(19) United States
(12) Patent Application Publication
(10) Pub. No.: US 2015/0083981 A1
(43) Pub. Date: Mar. 26, 2015

(54) CONCENTRIC SLAVE CYLINDER REMOVAL TOOL

(71) Applicant: Ronald D. Kruger, Ann Arbor, MI (US)

(72) Inventor: Ronald D. Kruger, Ann Arbor, MI (US)

(21) Appl. No.: 14/036,348

(22) Filed: Sep. 25, 2013

(51) Int. Cl. B25B 27/00; B25B 5/14

(52) U.S. Cl. CPC B25B 27/0035; B25B 5/14
USPC 254/100; 269/287

(57) ABSTRACT

In at least one implementation, a tool for a transmission piston assembly having a housing mounted to a transmission case includes a base plate, a reaction member, a connection member and an actuator. The reaction member is fixed in place relative to the transmission case and the connection member is adapted to interconnect the base plate to the housing of the piston assembly. The actuator is adapted to engage the reaction bar and displace the base plate relative to the reaction member to displace the housing relative to the transmission case. In at least some implementations, the amount of movement of the piston assembly may be limited to a threshold or less to prevent damage to the transmission. The actuator, base plate and/or reaction member may be constructed and arranged to provide a stop that ensures the threshold amount of movement is not exceeded.

### FIELD

The present disclosure relates to a tool for repair or removal of a concentric slave cylinder from a vehicle transmission.

### BACKGROUND

Certain transmissions include a hydraulic piston assembly, such as a concentric slave cylinder, that is accessible from the exterior of the transmission, and may be mounted to the exterior of the transmission case. The piston assembly may include a piston rod that extends into an interior of the transmission and is coupled to a clutch mechanism of the transmission and is operable to actuate the clutch mechanism. The piston rod also is coupled to a piston of the piston assembly mounted to the transmission. Accordingly, repair of the piston assembly has required the transmission to be removed from the vehicle to prevent damage to the clutch mechanism that may be caused by undue movement of the piston rod, this is costly and time consuming. Likewise, damaging the transmission during the piston assembly repair is also costly.

### SUMMARY

In at least one implementation, a tool for a transmission piston assembly having a housing mounted to a transmission case includes a base plate, a reaction member, a connection member and an actuator. The reaction member is fixed in place relative to the transmission case and the connection member is adapted to interconnect the base plate to the housing of the piston assembly. The actuator is adapted to engage the reaction bar and displace the base plate relative to the reaction member to displace the housing relative to the transmission case. In at least some implementations, the amount of movement of the piston assembly may be limited to a threshold or less to prevent damage to the transmission. The actuator, base plate and/or reaction member may be constructed and arranged to provide a stop that ensures the threshold amount of movement is not exceeded.

A clamp for a piston rod may be coupled to a piston of a piston assembly that is coupled to a transmission case. The clamp may include a pair of clamp bodies each having a first surface and a second surface opposite the first surface, and a clamp surface defined in a protrusion that extends from the second surface such that the clamp surface is offset from the second surface. The protrusion is adapted to be at least partially received into an opening of a transmission case in which the piston rod is received. The protrusion may enable the clamp surface to extend away from a main body or support surface of the clamp and enable the clamp surface to engage a piston rod at a location at least partially beneath an outer surface of the transmission case, and/or permit the clamp surface to remain clear of a piston connected to the piston rod.

In at least some implementations, a tool is provided for a transmission piston assembly that has a housing mounted to a transmission case The tool includes a base plate, a reaction member, a base plate support, a piston actuator and an actuator. The reaction member has at least one support by which the reaction member is fixed in place relative to the transmission case. A connection member interconnects the base plate to the housing of the piston assembly. The base plate support is adapted to engage the base plate and the piston assembly housing to limit movement of the piston assembly housing toward the base plate. The piston actuator has a piston engaging feature adapted to displace a piston of the piston assembly relative to the housing when the tool is connected to the piston assembly. And the actuator is adapted to engage the reaction bar and displace the base plate relative to the reaction member to displace the housing relative to the transmission case. In this way, the piston assembly can reliably, controllably and repeatably be moved away from the transmission case to facilitate repair or replacement of the piston assembly.

In some forms, the piston assembly may include a piston coupled to a piston rod and lifting the piston assembly off the transmission case may provide access to the piston rod to permit it to be decoupled from the piston. The tool may also include a piston rod clamp used to decouple the piston rod and piston, or the clamp may be considered to be a separate component. Once decoupled, the remainder of the piston assembly can be entirely removed from the transmission without having to remove the piston rod and without damaging the transmission. Further, in at least some forms, this can be accomplished without having to remove the transmission from the vehicle resulting in much easier and less expensive repair of the piston assembly and transmission.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a slave cylinder puller tool;

FIG. 2 is a plan view of the slave cylinder puller tool and a piston rod clamp used to remove the slave cylinder piston assembly from the transmission;

FIG. 3 is a fragmentary side view showing the puller tool mounted on a slave cylinder that is mounted to the transmission;

FIG. 4 is a view similar to FIG. 3 showing the slave cylinder moved away from the transmission and coupled with a piston rod;

FIG. 5 is a sectional view showing a piston rod clamp coupled to the piston rod to permit the piston assembly to be removed from the piston rod;

FIG. 6 is a plan view of a cross bar of the puller tool;

FIG. 7 is a side view of the cross bar;

FIG. 8 is a side view of an engagement arm of the puller tool;

FIG. 9 is a plan view of the piston rod clamp; and

FIG. 10 is a side view of one part of the piston rod clamp showing a piston rod engagement surface.

### DETAILED DESCRIPTION

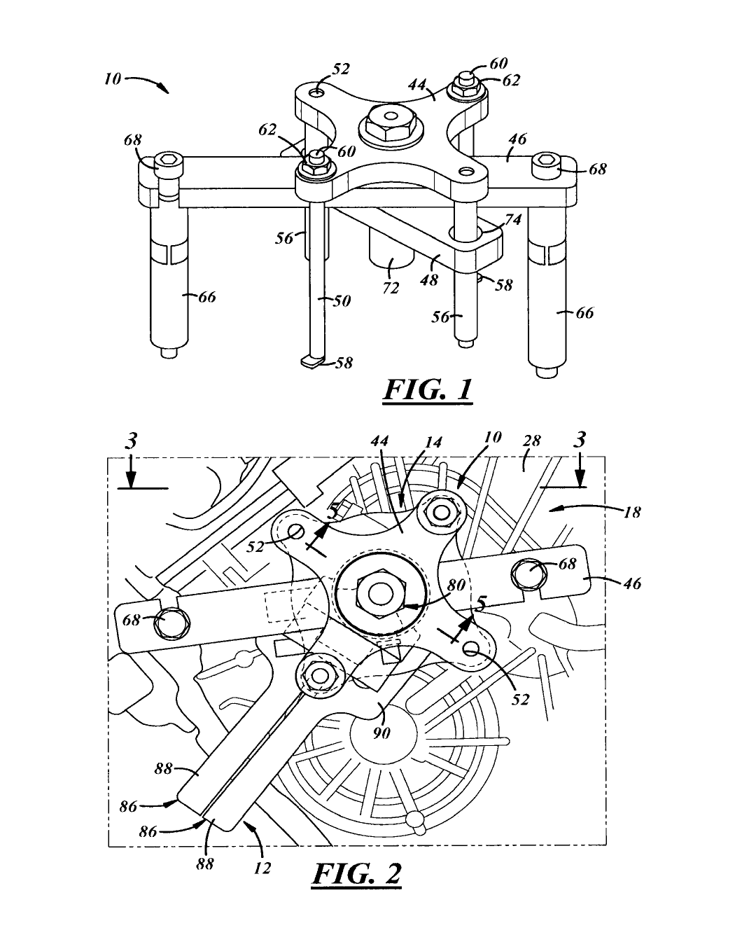

Referring in more detail to the drawings, FIGS. 1-5 illustrate a puller tool 10 and a piston rod clamp 12 that may be used to remove a piston assembly 14 of a concentric slave cylinder 16 from a vehicle transmission 18. The slave cylinder piston assembly 14 may be mounted to an exterior of the transmission 18, or otherwise is accessible from an exterior of the transmission, and is coupled to a piston rod 20 that extends into the transmission 18. The piston rod 20 is coupled to a transmission clutch and actuates the clutch in response to actuation of the piston assembly 14, in known manner. Because the piston assembly 14 is connected to the piston rod 20, the piston assembly 14 cannot simply be pulled off the transmission to repair or replace it. Doing so would cause the piston rod 20 to damage the clutch and require significant transmission repair.

To prevent damage to the clutch, the puller tool 10 permits and controls limited movement of the piston assembly 14 relative to the transmission 18. The movement is within a given tolerance that is known to avoid damage to the clutch yet expose or provide access to at least a portion of the piston rod 20. The piston rod clamp 12 may then be used to hold the piston rod 20 and permit removal of the piston assembly 14 from the piston rod 20. Thereafter a repaired or replacement piston assembly can be connected to the piston rod 20 and the assembly reconnected to the transmission 18. In at least some implementations, this can be accomplished while the transmission 18 is in place on the vehicle such that the transmission does not need to be disconnected from and reconnected to the vehicle.

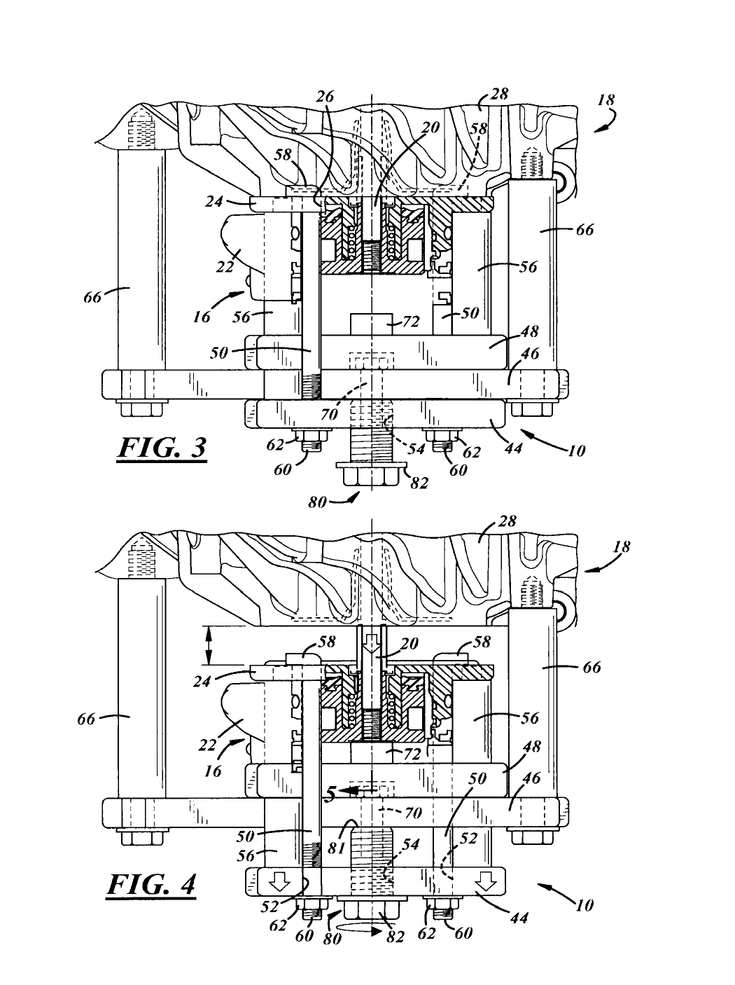

In more detail, as shown in FIGS. 3-5, the piston assembly 14 may include a housing 22 having a mounting flange 24 that has openings 26 through which fasteners (e.g. bolts or machine screws) may extend to releasably secure the piston assembly 14 to a transmission case 28. A seal 30 may be provided between the mounting flange 24 and the transmission case 28. The piston assembly 14 may include a piston 32, one or more seals 34, and the housing 22 that may also include a dust/contaminant cover 36 for the piston. The piston 32 may include threads 38 that mate with threads on the piston rod 20 and a cylindrical support 40 in which a portion of the piston rod 20 extends. In use, the piston 32, and hence the piston rod 20, may be driven by hydraulic fluid in a pressure chamber defined between the piston 32 and the housing 22 (and one or more seals), and by a return spring 42 that may return the piston 32 to a home position absent hydraulic pressure acting on the piston. To remove the piston assembly 14 from the transmission, the bolts holding the mounting flange 24 to the transmission case 28 are removed and the puller tool 10 is connected to the piston assembly 14.

As shown in FIGS. 1-4, the puller tool 10 includes a base plate 44, a reaction member 46, a piston actuator 48, and one or more connection members 50 that couple the mounting flange 24 of the piston assembly 14 to the base plate 44 so that movement of the base plate 44 results in movement of the mounting flange 24. The base plate 44 includes holes 52 generally aligned with the openings 26 in the mounting flange 24 and a threaded opening 54. While shown as generally X-shaped, the base plate 44 could have any suitable shape. Support posts 56 may include reduced diameter ends that are received in two opposed holes 52 of the base plate 44 and opposite ends that may be received in corresponding openings 26 of the mounting flange 24. The support posts 56 may be rigid and ensure a given separation between the base plate 44 and mounting flange 24.

A connection member 50 may be provided in one or both of the remaining holes 52 in the base plate 44 such that the connection members extend into the corresponding or aligned openings 26 in the mounting flange 24. In the implementation shown, for example in FIGS. 3, 4 and 8, the connection members 50 may include hooks 58 or bent ends that extend through the mounting flange openings 26, and threaded opposite ends 60 that extend through the holes 52 in the base plate 44. Nuts 62 may be secured to the threaded ends 60 to securely clamp the base plate 44 and mounting flange 24 on the support posts 56, with the hooks 58 engaged with a lower surface 64 of the mounting flange 24. The connection members 50 may be formed from a rigid material, like metal, and may be substantially inextensible. In this way, the base plate 44 and mounting flange 24 are securely connected together and movement of the base plate 44 will cause a corresponding movement of the mounting flange 24. And the support posts 56 may provide additional stability to prevent canting, rocking or other movement of the piston assembly 14 relative to the base plate 44 to ensure controlled and repeatable movement of the piston assembly relative to the transmission 18.

The reaction member 46 may be received between the base plate 44 and the piston assembly 14. The reaction member 46 may be retained in position adjacent to the base plate 44 by one or more support posts 66. At one end, the support posts 66 may be received in existing openings in the transmission case 28 (which openings may be threaded) and at their other end, the support posts 66 may bear on and be held against the reaction member 46, such as by fasteners 68. The support posts 66 may be rigid to hold the reaction member in place relative to the transmission case 28 under the forces applied to the puller tool 10, as set forth herein. In one form the support posts 66 are formed from metal. The reaction member 46 may be defined by a rigid plate or bar of any suitable material and is shown as being formed from metal. The bar is shown as being rectangular, but could be of any desired shape and includes a portion that is aligned with the threaded opening 54 of the base plate 44. A fastener 70 may be provided to connect the reaction member 46 with the base plate 44 to facilitate their handling and use as a single unit. Of course, this is only for convenience and they could be entirely separate, if desired.

As shown in FIGS. 3, 4, 6 and 7, the piston actuator 48 is disposed adjacent to the piston assembly 14 in use and includes a knob 72 or other protuberance that is adapted to engage the piston 32 within the piston assembly 14. This may displace the piston 32 against its return spring 42 so that the force of the return spring 42 does not need to be overcome during removal of the piston assembly 14 as will be described later. A pair of openings 74 through the piston actuator 48 receive the base plate support posts 56 and thus, maintain the orientation of the piston actuator 48 relative to the base plate 44 and piston assembly 14 in use. A recess 76 may provide clearance for a head 78 or other portion of the fastener 70 that connects the reaction member 46 and base plate 44. In the implementation shown, the piston actuator 48 is a rectangular bar or plate with a depending knob 72 that engages the piston 32. The piston actuator 48 could have any suitable shape and be formed of any suitable material.

To lift the piston assembly 14 from the transmission case 28, the fasteners holding the mounting flange 28 to the case 28 are removed. Thereafter, the reaction member support posts 66 are coupled to the case 28 and the ends of the base plate support posts 56 are located in the openings 52, 26 of the base plate 44 and mounting flange 24, respectively (with the base plate support posts 56 extending through the piston actuator openings 74). The connection members 50 are then coupled to the base plate 44 and mounting flange 24 such that the hooks 58 are inserted through the openings 26 in the mounting flange 24 and their opposite ends 60 are coupled to the base plate 44. In this way, the base plate 44 and mounting flange 24 are coupled together. The piston actuator 48 is trapped between the piston 32 and the reaction member 46 and when the connection members 50 are securely connected to the base plate 44, the knob 72 engages and displaces the piston 32 against its return spring 42. This moves the piston rod 20 further into the transmission 18 and thereby permits further movement of the mounting flange 24 away from the transmission case 28 with correspondingly less effective movement of the piston rod 20 relative to its clutch.

Next, an actuator 80 may be used to drive the base plate 44 away from the reaction member 46. In the implementation shown, the actuator is a bolt 80 or threaded shank that is received in the threaded opening 54 of the base plate 44 and rotated until an end 81 (FIG. 4) of the bolt 80 engages the reaction member 46. Further rotation of the bolt 80 moves the base plate 44 away from the reaction member 46, which is held against movement on the case 28 (via its support posts 66). As the base plate 44 moves, the hooks 58 pull the mounting flange 24 away from the case 28 and provide a clearance therebetween. A stop surface, such as a head 82 of the bolt 80 may provide a physical limit to the distance that the base plate 44 can be moved away from the reaction member 46, and hence the mounting flange 24 can be moved away from the transmission case 28. Otherwise, a visual indicator of the amount of base plate/mounting flange movement or other signal may be provided. In this way, movement beyond a maximum or threshold amount can reliably be avoided and in a simple manner. In at least some implementations, the mounting flange 24 may be moved off of the transmission case by between 2 mm and 40 mm or more, with one presently tested implementation being limited to 13 mm to prevent damage to the transmission. Hence, in that tested implementation, the stop surface 82 ensures a maximum movement of 13 mm of the mounting flange 24 from the transmission case 28. Now that the piston assembly 14 has been moved off the transmission case 28, the piston rod clamp 12 can be engaged with the piston rod 20 to facilitate removal of the piston 32 and remainder of the piston assembly 14 from the piston rod 20.

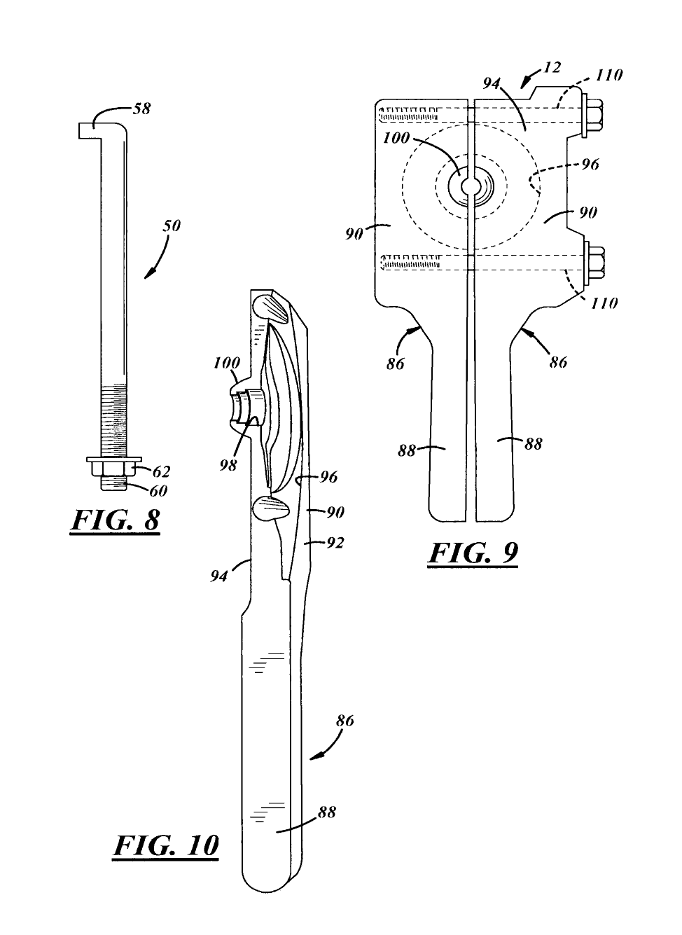

The piston rod clamp 12 is shown in FIGS. 2, 5, 9 and 10. In at least some implementations (and as shown), the piston rod clamp 12 includes two opposed members 86, each having a handle 88 and a clamp body 90. The handles 88 may be elongated rigid members adapted to extend outwardly beyond the puller tool 10 to permit a user to grasp the handles 88 even when the puller tool 10 is in place on the piston assembly 14 and transmission case 28. The clamp bodies 90 may be arranged to provide clearance with adjacent components and specifically to be received between the piston assembly mounting flange 24 and the transmission case 28. In the implementation shown, the clamp bodies 90 have generally flat first and second surfaces 92, 94 adapted to be received adjacent to the mounting flange 24 and transmission case 28, respectively. The thickness of the clamp bodies 90 is less than the maximum permitted movement of the mounting flange 24 away from the transmission case 28. Further, the clamp bodies 90 may include a recess 96 in the first surface 92 disposed adjacent to the mounting flange 24 in assembly. The recess 96 may provide clearance for the mounting flange 24 and/or connection member hooks 58, for example.

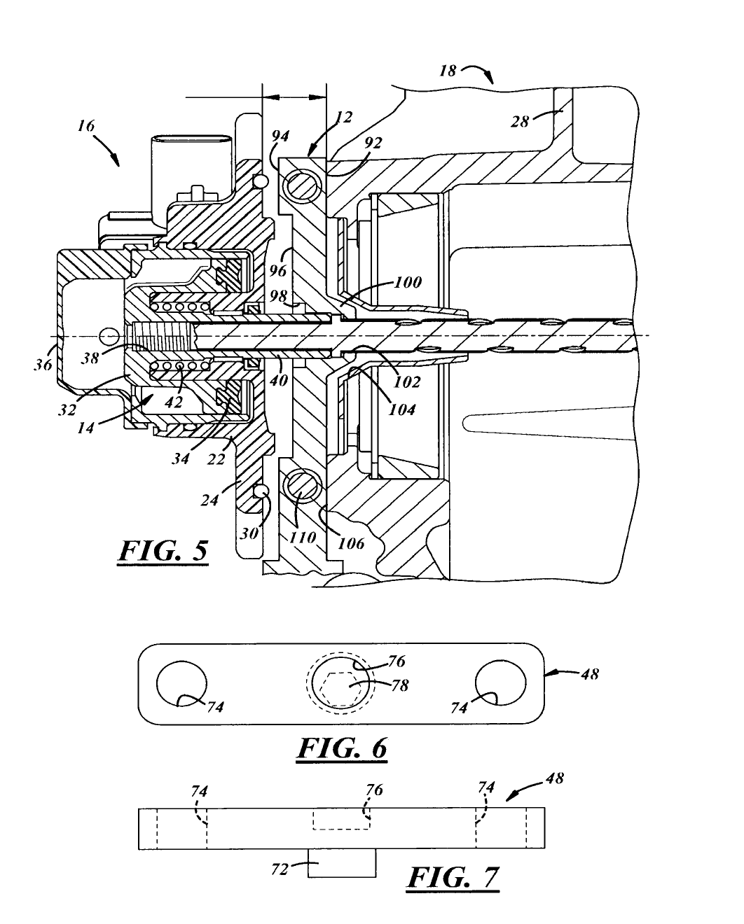

The clamp bodies 90 may each have a stepped cavity 98 defined in part by a protrusion 100 (or portion of a protrusion) extending from their second surfaces 94 so that the protrusions 100 extend from the opposite surface of the recess 96. The cavity 98 and protrusion 100 of each clamp body 90 may be in the shape of a half-cylinder and adapted to form a generally cylindrical bore and generally cylindrical (or frustoconical) protrusion 100 when the clamp bodies 90 are positioned adjacent to each other. The cavity 98 is arranged to provide clearance for the piston rod support 40 of the piston 32 and to ensure that a clamp surface 102 of the protrusion 100 engages only the piston rod 20 and not the piston 32. The shape of the protrusion 100 permits the clamp surface 102 of each clamp body 90 to be disposed beneath or outside of the piston rod support 40, which may extend into a recess 104 (FIG. 5) in the transmission case 28 (i.e. beneath an outer surface 106 of the case 28) even when the piston assembly 14 has been lifted from the case 28. This permits the piston rod clamp 12 to engage and hold onto the piston rod 20 and not the piston 32, and facilitate relative rotation between the piston 32 and piston rod 20, as will be discussed further below. The cavities 98 and clamp surfaces 102 may be formed smooth and of a size to prevent deformation or damage to the piston rod 20 in use as the piston rod can remain in use with the transmission 18. The clamp surfaces 102 may be at least 2 mm thick to improve holding the piston rod 20 and prevent providing too thin of an area of contact on the piston rod, which could otherwise damage the piston rod. When the clamp bodies 90 are fully brought together, the clamp surfaces 102 may be formed with a smooth inner radius that is the same as the piston rod 20 radius so that even higher than needed clamping forces do not unduly mar or damage the piston rod 20 and so the piston rod can remain in use with the transmission. In at least some forms, there is a small clearance or gap of 1 mm or more when the clamp bodies are brought together, and this clearance may decrease but not disappear entirely when the clamp bodies are squeezed or compressed and/or secured together.

To more firmly clamp the piston rod 20, the handles 88 may be squeezed together manually. Or, as optionally shown in FIG. 10, the clamp bodies 90 may be held together by one or more bolts 110 or other fastener(s) to ensure a steady and consistent clamping force and/or remove the need for someone to hold onto the handles 88. Of course, other arrangements may be employed, such as a clamp wherein the clamp bodies 90 are not separate from each other, and may be pivoted or otherwise moveable like pliers, a C-clamp, or any other suitable design.

In use, the piston rod clamp bodies 90 are inserted beneath the mounting flange 24 when the mounting flange 24 is raised off the transmission case 28. The protrusion 100 is positioned within the transmission case recess 104 (or bore) and the clamp surfaces 102 are located adjacent to the piston rod 20. Thereafter, the clamp bodies 90 are moved toward each other to clamp and hold the piston rod 20. With the reaction bar posts 66 removed from the transmission case 28, the puller tool 10 can be rotated to rotate the rest of the piston assembly 14 relative to the piston rod 20 (the elongated reaction bar 46 may be used for extra leverage for rotating the puller tool 10 and piston assembly 14). This will unscrew the piston 32 from the piston rod 20 and permit the piston assembly 14 to be completely removed from the piston rod 20. The removed piston assembly 14 can then be taken off the puller tool 10 and a new piston assembly 14 readied for installation.

To install a new piston assembly 14, the new piston assembly can be loaded into the puller tool 10 with the connection member hooks 58 and support posts 56 mated with the mounting flange 24 of the new piston assembly in the same manner as the recently removed piston assembly. The reaction bar 46 may be in place, and the actuator bolt 80 may be rotated to engage the piston actuator 48 with the piston 32 and depress or move the piston 32 against its return spring 42. This prevents the piston assembly 14 from unduly engaging the piston rod clamp 12 as the new piston assembly is rotated onto the piston rod 20, as discussed below. With the new piston assembly 14 loaded onto the puller tool 10, the puller tool 10 may then be rotated relative to the piston rod 20 to screw the piston 32 of the new piston assembly 14 onto the piston rod 20. An adhesive may be used on the mating threads to improve the connection between the piston 32 and piston rod 20, if desired. The rotation of the puller tool 10 may be done in the same manner as the removal of the prior piston assembly, but in the opposite direction.

After the piston 32 is connected to the piston rod 20, the piston rod clamp 12 may be removed and the reaction bar support posts 66 may be connected to the transmission case 28. To lower the piston assembly 14 onto the transmission case 28, the actuator bolt 80 may be retracted. This lowers the base plate 44 relative to the reaction bar 46 which also lowers the mounting flange 24 relative to the transmission case 28. When the mounting flange 24 is lowered to the case 28, the connection members 50 and the base plate support posts 56 may be removed to remove the puller tool 10 from the piston assembly 14. Fasteners may then be inserted through the mounting flange openings 26 and tightened to connect the mounting flange 24 to the transmission case 28. Thereafter, the dust cover 36 and any electrical and hydraulic or other fluid connections to the piston assembly 14 may be made.

In this way, an exteriorly accessible piston assembly 14 may be serviced or replaced without having to remove the piston rod 20 from the transmission 18, and without having to remove the transmission 18 from the vehicle. This may be done to replace a seal, or to replace a defective piston or housing, for example. Of course, the entire piston assembly 14 may be replaced, if desired. The puller tool 10 and piston rod clamp 12 may be manually manipulated by a single person and in a relatively short period of time to simply and effectively permit repair or replacement of the piston assembly.

What is claimed is:

1. A tool for a transmission piston assembly that has a housing mounted to a transmission case, comprising:
a base plate;
a reaction member fixed in place relative to the transmission case;
a connection member adapted to interconnect the base plate to the housing of the piston assembly; and
an actuator adapted to engage the reaction bar and displace the base plate relative to the reaction member to displace the housing relative to the transmission case.

2. The tool of claim 1 wherein a positive stop is associated with the actuator to limit the extent to which the base plate may be moved relative to the reaction member.

3. The tool of claim 1 wherein the connection member includes an end feature adapted to be received at least partially in an opening of the housing.

4. The tool of claim 1 which also includes a piston actuator adapted to engage and displace a piston of the piston assembly relative to the housing as the base plate is displaced by the actuator.

5. The tool of claim 4 wherein the piston actuator is separate from the base plate and the reaction member is located between the base plate and the piston actuator.

6. The tool of claim 1 which also includes at least one support rod extending between the housing and the base plate to limit relative movement between the housing and base plate as the base plate is moved relative to the reaction member.

7. The tool of claim 1 wherein the base plate includes a threaded bore and the actuator is threadedly received in the bore and rotation of the actuator moves the base plate relative to the reaction member.

8. The tool of claim 7 wherein the actuator includes an end engageable with the reaction member and an enlarged head spaced from said end that is engageable with the base plate when the base plate is displaced relative to the reaction member by a threshold amount to define a positive stop to limit movement of the base plate relative to the reaction member beyond said threshold amount.

9. The tool of claim 1 which also comprises a clamp for a piston rod coupled to a piston of the piston assembly, the clamp including a pair of opposed clamp surfaces adapted to engage the piston rod and not the piston to permit the piston assembly to be moved relative to the piston rod.

10. The tool of claim 9 wherein the clamp is movable independently of the base plate, reaction member and actuator.

11. The tool of claim 10 wherein the clamp is not connected to and is a separate component from the base plate, reaction member and actuator.

12. The tool of claim 9 wherein the clamp surfaces are defined by a pair of clamp bodies each having a first surface and a second surface opposite the first surface, a clamp surface defined in a protrusion that extends from the second surface such that the clamp surface is offset from the second surface, where the protrusion is adapted to be received into an opening of a transmission case in which the piston rod is received.

13. A clamp for a piston rod coupled to a piston of a piston assembly that is coupled to a transmission case, comprising:
a pair of clamp bodies each having a first surface and a second surface opposite the first surface, a clamp surface defined in a protrusion that extends from the second surface such that the clamp surface is offset from the second surface, where the protrusion is adapted to be at least partially received into an opening of a transmission case in which the piston rod is received.

14. The clamp of claim 13 wherein the second surface is adapted to be disposed parallel to an outer surface of the transmission case and the protrusion is adapted to be received in the opening beneath the outer surface of the transmission case.

15. The clamp of claim 13 wherein the protrusion defines a stepped cavity where the clamp surface is smaller in diameter than a portion of the cavity closer to the second surface.

16. A tool for a transmission piston assembly that has a housing mounted to a transmission case, comprising:
a base plate;
a reaction member having at least one support by which the reaction member is fixed in place relative to the transmission case;
a connection member adapted to interconnect the base plate to the housing of the piston assembly;
a base plate support member engaged with the base plate and engageable with the piston assembly housing to limit movement of the piston assembly housing toward the base plate;
a piston actuator having a piston engaging feature adapted to displace a piston of the piston assembly relative to the housing when the tool is connected to the piston assembly; and
an actuator adapted to engage the reaction bar and displace the base plate relative to the reaction member to displace the housing relative to the transmission case.

17. The tool of claim 16 wherein a positive stop is associated with the actuator to limit the extent to which the base plate may be moved relative to the reaction member.
